(19) United States
(12) Patent Application Publication
(10) Pub. No.: US 2003/0159264 A1
(43) Pub. Date: Aug. 28, 2003

(54) Automotive roof module and method of assembly of the module to an automotive vehicle

(75) Inventors: David G. McLeod, Rochester, MI (US); Douglas P. McCollum, La Wantzenau (FR)

Correspondence Address: Scott A. Chapple, Dobrusin & Thennisch PC, Suite 311, 401 South Old Woodward Avenue, Birmingham, MI, 48009, US

(73) Assignee: The Dow Chemical Company

(21) Appl. No.: 10/081,506

(22) Filed: Feb. 22, 2002

(51) Int. Cl. B23P 11/00

(52) U.S. Cl. 29/428

(57) ABSTRACT

There is disclosed a roof module (10) configured for assembly to a body of an automotive vehicle. The module is comprised of a roof portion (12) and one or more transparent panels (14) wherein the one or more transparent panels (14) is attached to the roof portion (12) prior to assembly of the module (10) to the body of the vehicle.

### TECHNICAL FIELD

The present invention relates to a roof module suitable for assembly to an automotive vehicle. More particularly, the invention relates to a roof module that includes one or more transparent panels (e.g., a windshield, a backlite, side glass or the like) prior to assembly of the module to an automotive vehicle. The invention also relates a method of assembly of the roof module to the automotive vehicle.

### BACKGROUND OF THE INVENTION

Automotive vehicle assembly techniques have historically involved the assembly of a large number of individual different components along an assembly line to form an automotive vehicle. More recently, however, automotive assembly techniques have become more modular in that components of a vehicle are being assembled into modules at one site and then the modules are assembled together for forming the vehicle at another site. By way of example, the roof of an automotive vehicle is desirably provided to a vehicle assembly line as a pre-assembled module, including vehicle components typically packaged in the roof, such as sun or moon roofs, overhead consoles, headliners and other components. The pre-assembled roof module often is assembled at a site of an automotive parts supplier and then shipped to an original equipment manufacturer for assembly into a vehicle.

It has been the general practice to provide roof modules that incorporate the roof panel as the only vehicle body structure. The incorporation of pillars, glass or other transparent panels and the roof rail into the roof module has been avoided, given that the resulting structure would be cumbersome to handle and would restrict the amount of space available for allowing assembly of seats and other components into the interior of the vehicle prior to assembly of the roof module to the body structure. Thus, there is a need for a roof module suitable for assembly to a body of an automotive vehicle wherein the module may be assembled to the vehicle relatively easily without unduly complicating assembly of other portions of the vehicle.

### SUMMARY OF THE INVENTION

The present invention meets the above needs and others by providing a roof module for installation into an automotive vehicle, comprising:

a) a roof portion having at least one edge;

b) a transparent panel having a bottom edge adapted for attachment to a body of the automotive vehicle during assembly of the automotive vehicle, and a top edge that is adhesively secured to the roof portion adjacent the at least one edge of the roof portion;

wherein the transparent panel is selected from the group consisting of a windshield, a backlite, side glass and combinations thereof.

The present invention also provides an improved automotive vehicle assembly process, pursuant to which a roof module such as the above is prepared at a first site and transported to a second site for assembly to the automotive vehicle.

As can be seen from the above, and as will be demonstrated herein, the present invention advantageously permits for the assembly of complex roof module systems in a relatively short amount of time. Accessibility of assembly workers to roof module components will be improved by shifting component installation steps to times prior to assembly of the roof panel to the vehicle. As a result, original equipment automotive manufacturers will be able to better deploy resources for building automotive vehicles. Automotive vehicle suppliers also will benefit from the ability to exert greater controls over component and assembly quality. Other advantages will be apparent from the following discussion.

### BRIEF DESCRIPTION OF THE DRAWINGS

FIG. 1 is a perspective view of a roof module being assembled to a body portion of an automotive vehicle.

FIG. 2 is a sectional view of an exemplary roof portion of the roof module of FIG. 1.

### DETAILED DESCRIPTION OF THE PREFERRED EMBODIMENT

Generally, the present invention relates to a roof module that includes a roof portion and one or more transparent (e.g., glass) panels such as a windshield, a backlite, side glass and the like. Preferably, the one or more transparent panels are attached to the roof portion prior to assembly of the module to a body of an automotive vehicle. In one embodiment, the roof module includes at least one transparent panel selected from the windshield, the backlite and fixed side glass secured to the roof portion prior to assembly of the module to the vehicle. In another embodiment, the roof module includes at least two transparent panels selected from the windshield, the backlite and fixed side glass secured to the roof portion prior to assembly of the module to the vehicle.

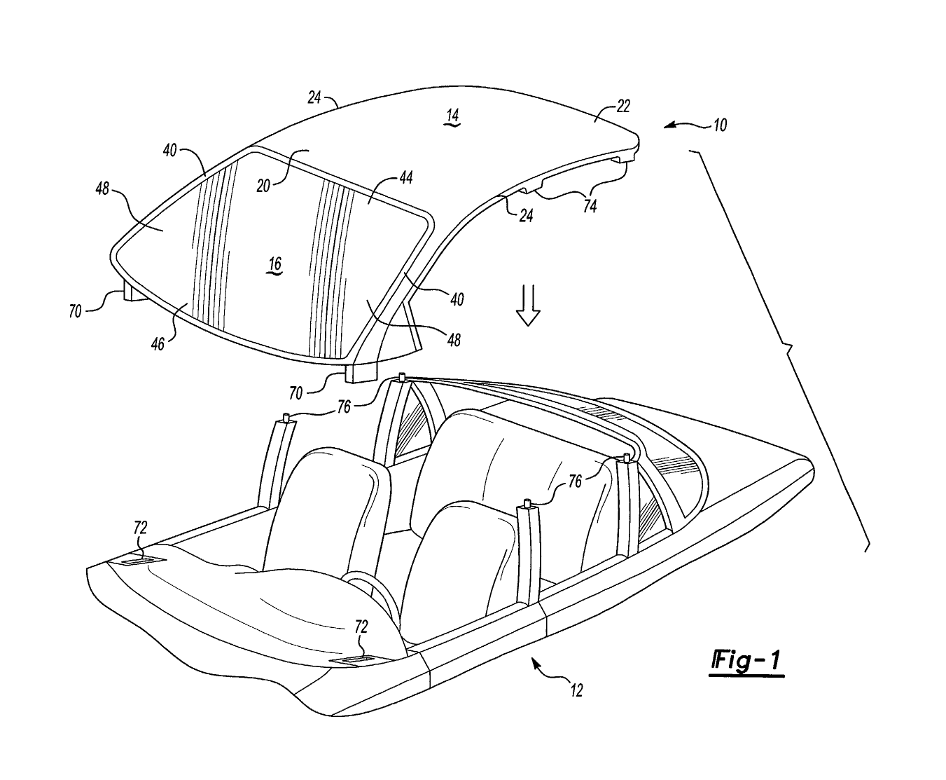

Referring to FIG. 1, there is illustrated an exemplary roof module 10 configured for assembly to a body 12 of an automotive vehicle. The module 10 generally includes a roof portion 14 attached to a transparent panel 16 wherein the roof portion 14 and the transparent panel 16 may be assembled as a single integrated unit to the body 12 of the automotive vehicle.

In FIG. 1, the roof portion 14 is generally rectangular and includes a forward edge 20 (e.g., a header), a rearward edge 22 (e.g., a rear header) and a pair of side edges 24 (e.g., side rails). Alternatively, however, the roof portion 14 may be formed in a variety of shapes and configurations depending upon the vehicle to which the roof module 10 is being attached and depending upon other considerations.

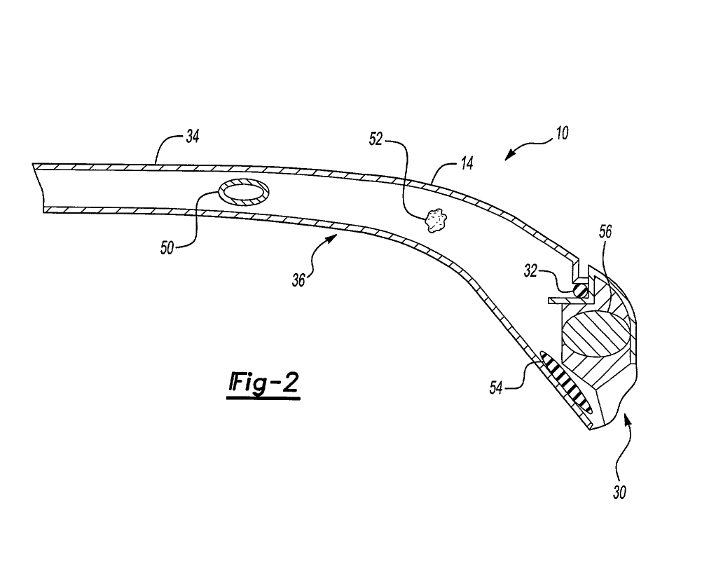

The roof portion 14 of the roof module 10 may include various core components (i.e., components that structurally define the roof module) such as a headliner, a roof panel, roof rail assemblies and the like. Referring to FIG. 2, there is illustrated a sectional view of the roof portion 14 having a roof rail assembly 30. In the embodiment shown, the roof portion 14 includes a roof panel 34 attached to the roof rail assembly 30 at least partially with a bonding system, which preferably includes an adhesive 32. The roof panel 34 generally opposes a headliner 36 forming a space therebetween. Preferably, the headliner 36 is at least partially composed of one or more foam-in-place materials, which allow various peripheral components to be installed in the roof module 10 prior to full formation of the headliner 36. The rail assembly 30 generally forms a substantially enclosed tunnel.

Preferably, the roof module of the present invention includes one or more pillars extending outwardly away from the edges of the roof portion and preferably extending away from corners defined by the edges of the roof portion. The pillars may include structural reinforcement or noise management system disposed within or upon portions of the pillars. Moreover, the pillars may include one or more of the A-pillars, B-pillars, C-pillars or other pillars. In FIG. 1, the roof module 10 includes a pair of A-pillars 40 extending from corners of the roof portion 14.

The transparent panel of the roof module may be a backlite, a windshield, single or segmented glass panels for open roof systems or fixed side glass of the automotive vehicle. The transparent panel may be formed of a variety of materials such as polycarbonate/PMMA glass. The transparent panel may include a single or multiple layers (e.g., a silica layer and a polymer layer). In FIG. 1, the panel 16 is a generally rectangular windshield and includes a top edge 44, a bottom edge 46 and a pair of side edges 48. In preferred embodiments, the panel 16 may include a plastic (e.g., a PVC or RIM plastic) frame or encapsulation that may partially or fully cover some or all of the edges 44, 46, 48 of the panel.

Generally, a roof module according to the present invention may include a variety of peripheral components in addition to or integrated into the roof portion and glass panel for increasing the strength of the module, for adding to the functionality of the roof module, for protecting the vehicle from environmental conditions, for improving the aesthetic appearance of the module and the like. For example, and without limitation, the roof module may include one or more roof bows, one or more wire harnesses, electronic equipment, a global positioning system (GPS), a compass, an antennae, loud speakers, a phone, an alarm, lighting (e.g., a center high mounted stop light), a color monitor, temperature sensors, transmitters, receivers, a sun roof, a moon roof, anti-flutter and reinforcing patches, motors, seals, fluid management structure (e.g., roof diches) baffles or the like. In one preferred embodiment, the roof module includes a sun roof package that includes aluminum extrusions, a cable driven opening and closing system driven by an electric motor and a fluid drain system.

The roof module may also include components such as seals for assisting the vehicle in fluid management (e.g. by repelling water, channeling water and the like). Additionally, the roof module may include various aesthetic features such as trim strip and the like.

In the exemplary embodiment of FIG. 2, the roof module 10 includes a wire harness 50 and a noise management system 52 disposed in the space between the headliner 36 and roof panel 34.

In preferred embodiments, vehicle impact countermeasures may be disposed in the roof module. For example, in FIG. 2, airbags 54 are disposed between the headliner 36 and roof rail assembly 30 and structural reinforcement 56 is disposed in the roof rail assembly 30. Other vehicle impact countermeasures may include structural reinforcements.

Roof Module Assembly

Assembly of the roof module will typically include the formation of a roof panel such as the roof panel 34 of FIG. 2. The roof panel may be formed according to a variety of metal forming techniques such as hydroforming, metal stamping, roll-forming, combinations thereof or the like. In preferred embodiments, the roof panel of the module is formed with portions that form at least a part of the roof pillars.

The headliner and any desired peripheral components of the roof module are preferably attached to the roof panel prior to assembly of the module to the body of the vehicle. The headliner, the peripheral components or both may be attached to the roof panel with fasteners, may be molded into place, may be adhesively secured or a combination thereof.

One or more transparent panels is attached to the roof portion, the pillars or both according to a variety of techniques. The panels may be attached with fasteners, they may be molded in place, they may be adhesively secured or a combination of such techniques may be used. In a preferred embodiment, the panels are at least partially attached to the roof portion with a bonding system (e.g., including a suitable adhesive, such as a urethane). Additionally, a primer may be applied to the roof portion (e.g., metal components of the roof portion), the glass panel, an encapsulation of the glass panel or a combination thereof to assist the adhesive in securing the glass panel to the roof portion. One suitable exemplary adhesive is sold under the trademark BETASEAL and is commercially available from the Dow Chemical Corporation, Midland, Mich.

The roof panel and pillars may be painted or unpainted prior to assembly of the roof module to the body of the automotive vehicle. In one preferred embodiment, however, at least a portion of the roof panel, the pillar, the rails assemblies or a combination thereof have a class A painted finish. Even more preferably, the roof panel, the pillars and the rail assemblies have a class A painted finish that allows the roof module to be assembled to the automotive vehicle without any substantial further painting of the roof module. Advantageously, assembly of a pre-painted roof allows automotive manufacturers the opportunity to paint the body of the vehicle and assemble various portions of the vehicle interior (e.g., front and back seats and the like) to the body of the vehicle prior to assembling the roof module to the vehicle. Moreover, since one or more of the glass panels, the roof pillars or both are part of the roof module, greater space is afforded to the automotive manufacturer for assembling component of the interior of the vehicle.

In the embodiment depicted in FIG. 1, the top edge 44 of the panel 16 is connected to the roof portion 14 adjacent its forward edge 20. Preferably, the side edges 48 of the panel 16 are connected to and extend with the pillars 40. The lower edge 46 is free (i.e., not connected to the body of the automotive vehicle) prior to assembly of the roof module 10 to the body of the vehicle. The panel 16 may be connected to the roof portion 14 and pillars 18 according to a variety of attachment techniques (such as fastening, welding, adhering interlocking or the like). Preferably, the panel 16 is at least partially connected to the roof portion 14, the pillars 18 or both with an adhesive and most preferably a urethane adhesive.

In highly preferred embodiments, the roof module and its attendant peripheral components are partially or fully testable prior to installation or assembly of the module to the automotive vehicle. Any electrical circuitry or electronic or electrical system equipment of the roof module may be tested according to various techniques including passing electric current to and through such circuitry and equipment. The structural integrity of the roof module may be tested by subjecting the roof module to various forces, impacts and the like.

Automotive Vehicle Assembly

Assembly of the roof module to the automotive vehicle generally will include attaching the roof module to the body of the vehicle with fasteners such as adhesives, mating structures and the like. Prior to assembly of the module to the body of the vehicle, various transportation techniques may be instituted for transporting the roof modules to an assembly line or other location where the modules are assembled to a vehicle.

The roof modules may be supplied to any variety of locations adjacent an automotive vehicle assembly line from an on-site facility or an off-site facility. In one embodiment, the modules are supplied on racks that are suitably cushioned or otherwise configured to protect the transparent panel and any paint finish provided on the module. Preferably the racks are mobile and can be positioned as desired adjacent the automotive vehicle assembly line. It is contemplated that the roof module may be formed in one designated area of an assembly plant and transported (e.g., via racks) to another designated area of the same assembly plant for assembly of the module to the body portion of the vehicle.

Manual or automated methods may be used to move the modules to the body of the vehicle. In a preferred embodiment, the modules are provided with removable handles that may be appropriately gripped by a robot. Thereafter, the robot can bring the roof module into an opposing position over a passenger compartment of the vehicle, place the module atop the vehicle and then release the handles.

The roof module may be positioned and secured on the body of the vehicle according to a variety of protocols and techniques. Preferably, the roof module and the body of the vehicle are formed with mating structures for assisting in attaching the roof module to the body. For example, and without limitation, the pillars of the roof module may include protrusions that matingly fit into openings located on the body of the vehicle. Alternatively, the pillars may include the openings and the roof module may include the protrusions. As another example, pillars of the body of the vehicle may include protrusions that matingly fit into openings in the roof portion (e.g., the edges of the roof portion). Alternatively, the pillars may include the openings and the roof portion may include protrusions.

Preferably, the mating structures assist in locating the roof module relative to the body of the vehicle during assembly. Moreover, the mating structures preferably assist in securing the roof module to the body of the vehicle such as by forming a snap-fit or interference fit. Adhesives and other fasteners may assist in securing the pillars to the body of the vehicle, to the roof portion or both. In a highly preferred embodiment, the mating structures self locate the roof module as a drop-in insert upon the body of the vehicle.

The roof module 10 of FIG. 1 is assembled to the body of a vehicle from the front of the vehicle. The module 10 is lowered into place on the body of the vehicle such that mating structures (e.g., protrusions 70) on the A-pillars 40 of the roof module 10 matingly engage mating structures (e.g., openings 72) of the body 12 of the vehicle and mating structures (e.g., openings 74) on the edges 20, 22, 26 of the roof portion 14 matingly engage mating structures (e.g., protrusions 76) on the B-pillars and C-pillars of the automotive vehicle.

In a particularly preferred embodiment, once in place, the transparent panel 16 is preferably attached to the body 12 (e.g., a metal, plastic or other structure) of the vehicle with a bonding system that includes one or more adhesives, primers or the like such, as those of commonly owned U.S. Pat. Nos. 5,115,086; 5,603,798; 5,792,811; 5,922,809; 5,976,305; 6,133,398, all of which are hereby expressly incorporated by reference for all purposes. Thus, the adhesive, primer or both may be a one-part composition or a multi-part (e.g. 2-part) composition. They may include encapsulated ingredients. Preferably, they are a urethane adhesive, particularly one prepared from an isocyanate and a polyol, and optionally a catalyst. One or more other ingredients may be included such as a plasticizer, a filler, a reinforcement, an elastomeric component, a stabilizer or the like. The adhesive may optionally include or be prepared from a pre-polymer as well.

Preferably, the bonding system is sufficient so that a relatively rapid cure is possible, e.g., less than about 4 hours and more preferably less than about 1 hour, and still more preferably less than about ½ hour, so that from the time of attaching the panel 16 to the body 12, relatively little time elapses before assembling the parts into the vehicle.

The resulting bonding system preferably results in lap shear strengths of preferably 150 psi (1033 kPa) or greater as determined according to ASTM D-3163 and demonstrate impact energy strength of 9 ft-lbs (12.2 Joules). Further, preferably the bonding system of the invention demonstrates a lap shear-strength after 60 minutes from application to substrates of about 30 psi (206 kPa) or greater, more preferably 60 psi (412 kPa) or greater and most preferably 80 psi (548 kPa) or greater. Lap shears are determined according to ASTM D-3163. Preferably the bonding system when cured demonstrates an elongation of 300 percent or greater as determined according ASTM D-638-91 and preferably greater than about 600 percent. In one preferred embodiment, the elongation is 700 percent or less.

Advantageously, the roof module may shorten the overall amount of time needed for assembly of an automotive vehicle by an automotive vehicle assembly line. For example, and without limitation, the roof portion and the transparent panel (e.g., the entire roof module) may be simultaneously assembled to the body of the automotive vehicle without having to separately attach one or more transparent panels before or after assembly of the roof of a vehicle to the body of the vehicle.

Also advantageous, the roof module may lessen the amount of space required for assembly of an automotive vehicle by an automotive vehicle assembly line. For example, and without limitation, packaging the roof portion and one or more transparent panels as a single roof module may allow the removal of equipment, racks and the like that may have previously been used to separately install the roof portion and the one or more transparent panels.

As discussed herein, the transparent panels also contemplate the integration of one or more features therein, as is encountered in the automotive field. For example, the transparent panel may include or otherwise be adapted for tint, reflective or other protective coating or film, antenna wire, lights, heaters, head-up display, wipers, screens, thermochromic materials, electrochromic materials, or the like. The panels may be provided with or without an encapsulating seal. One or more seals may also be added in an earlier or later processing step.

It should be understood that the invention is not limited to the exact embodiment or construction, which has been illustrated and described but that various changes may be made without departing from the spirit and scope of the invention.

What is claimed is:

1. A method of assembling a roof module to an automotive vehicle, comprising:
providing the roof module wherein the roof modules includes:
a) a roof portion having at least one edge;
b) a transparent panel having a bottom edge adapted for attachment to a body of the automotive vehicle during assembly of the automotive vehicle, and a top edge that is adhesively secured to the roof portion adjacent the at least one edge of the roof portion wherein the transparent panel is selected from the group consisting of a windshield, a backlite, side glass and combinations thereof; and
assembling the roof module to a body portion of an automotive vehicle.

2. A method as in claim 1 wherein the roof portion includes a roof panel and a foam-in-place headliner.

3. A method as in claim 1 wherein the roof portion includes a roof rail assembly.

4. A method as in claim 1 wherein the roof portion includes at least one peripheral component selected from the group consisting of a wire harness, a global positioning system, a temperature sensor, a speaker, a monitor, a sunroof package, a moonroof package and a light.

5. A method as in claim 1 further comprising a second transparent panel selected from the group consisting of a windshield and a backlite having a top edge and a bottom edge wherein the top edge is secured to the roof portion adjacent a second edge of the roof portion.

6. A method as in claim 1 wherein the transparent panel includes an encapsulation covering at least a portion of one of the edges of the transparent panel.

7. A method as in claim 1 wherein the roof portion includes at least one vehicle impact countermeasure selected from the group consiting of an air bag and a structural reinforcement.

8. A method as in claim 1 wherein the top edge of the transparent panel is adhesively secured to the roof portion with a urethane adhesive.

9. A method of assembling a roof module to an automotive vehicle, comprising:
providing the roof module wherein the roof module includes:
a) a roof portion having a forward edge, a rearward edge, a pair of side edges and a pair of A-pillars extending from adjacent opposing corners of the roof portion; and
b) a windshield having a top edge, a bottom edge and a pair of side edges wherein; (i) the top edge of the windshield is adhesively secured to the roof portion adjacent the forward edge of the roof portion and the side edges of the windshield are secured to the A-pillars; (ii) the bottom edge of the transparent panel is configured for attachment to a body portion of the automotive vehicle upon assembly of the roof module to the automotive vehicle; and (iii) the A-pillars and the body portion of the vehicle include corresponding mating structures for assisting in assembling the roof module to the body portion of the vehicle; and
assembling the roof module to the body portion of the vehicle by matingly fitting the mating structures of the A-pillars with the mating structures of the body portion and by adhesively securing the transparent panel to the body portion of the vehicle with a urethane adhesive.

10. A method as in claim 9 wherein a primer is utilized to assist the urethane adhesive in securing the transparent panel to the body portion.

11. A method as in claim 9 wherein the roof portion includes a roof rail assembly having structural foam disposed therein.

12. A method as in claim 9 wherein the roof portion includes at least one peripheral component selected from the group consisting of a wire harness, a global positioning system, a temperature sensor, a speaker, a monitor, a sunroof package, a moonroof package and a light.

13. A method as in claim 9 further comprising a second transparent panel selected from the group consisting of a windshield, a backlite having a top edge and a bottom edge wherein the top edge is secured to the roof portion adjacent a second edge of the roof portion.

14. A method as in claim 9 wherein the transparent panel includes an encapsulation covering at least a portion of one of the edges of the transparent panel.

15. A method as in claim 9 wherein the roof portion includes at least one vehicle impact countermeasure selected from the group consiting of an air bag and a structural reinforcement.

16. A method as in claim 9 wherein the top edge of the transparent panel is adhesively secured to the roof portion with a urethane adhesive.

17. A method of assembling a roof module to an automotive vehicle, comprising:
a) providing a roof portion having a peripheral edge, two forward corner portions and two rearward corner portions and at least two intermediate side portions;
b) providing a transparent panel having a top edge and a bottom edge, and being selected from the group consisting of a windshield, a backlite, side glass, and combinations thereof;
c) adhesively securing the transparent panel to the roof portion adjacent the peripheral edge of the roof portion with a urethane adhesive for forming a roof module; and
d) assembling the roof module to a body of an automotive vehicle.

18. A method as in claim 17 further comprising securing a pair of opposing and spaced apart A-pillars to said roof portion extending from adjacent opposing corners of the roof portion wherein the transparent panel is a windshield with side edges secured to the A-pillars.

19. A method as in claim 17 wherein the step of assembling the roof module to the body of the automotive vehicle includes connecting the roof portion of the vehicle to a pair of B-pillars and to a pair of C-pillars of the automotive vehicle body and includes connecting the bottom end of the transparent panel to the body using an adhesive.

20. A method as in claim 17 wherein the roof module includes a second transparent panel selected from the group consisting of a windshield, a backlite having a top edge and a bottom edge wherein the top edge is secured to the roof portion adjacent a second edge of the roof portion.

21. A method as in claim 17 wherein the roof module is assembled in a first designated area of an assembly plant and the roof module is assembled to the body portion in a second designated area of the assembly plant.
